(19) United States
(12) Patent Application Publication
(10) Pub. No.: US 2022/0018321 A1
(43) Pub. Date: Jan. 20, 2022

(54) IN-CYLINDER AIR INJECTION VIA DUAL-FUEL INJECTOR

(71) Applicant: Cummins Inc., Columbus, IN (US)

(72) Inventors: J. Steven Kolhouse, Columbus, IN (US); Anthony Kyle Perfetto, Columbus, IN (US)

(73) Assignee: Cummins Inc., Columbus, IN (US)

(21) Appl. No.: 17/490,162

(22) Filed: Sep. 30, 2021

Related U.S. Application Data
(63) Continuation-in-part of application No. 16/343,068, filed on Apr. 18, 2019.

(51) Int. Cl. F02M 43/04; F02M 43/02; F02B 1/10

(52) U.S. Cl. CPC F02M 43/04; F02B 2201/064; F02B 1/10; F02M 43/02

(57) ABSTRACT

A fuel system is provided, comprising: a liquid fuel source; a gaseous fuel source; and a dual injector having a first flow path in flow communication with the liquid fuel source and a second flow path in flow communication with gaseous fuel source, and an outlet in flow communication with the first and second flow paths and positioned to directly inject liquid fuel from the first flow path and gaseous fuel from the second flow path into a combustion chamber of a cylinder of an engine.

### CROSS-REFERENCE TO RELATED APPLICATIONS

This application is a continuation-in-part of U.S. patent application Ser. No. 16/343,068, titled “IN-CYLINDER AIR INJECTION VIA DUAL-FUEL INJECTOR,” filed on Apr. 18, 2019, which is a national phase filing of International Application No. PCT/US2016/059676, titled “IN-CYLINDER AIR INJECTION VIA DUAL-FUEL INJECTOR,” filed on Oct. 31, 2016, the disclosures of which being expressly incorporated herein by reference.

### TECHNICAL FIELD

The present invention relates generally to fueling systems and more particularly to systems and methods for providing injections of liquid fuel, gaseous fuel and/or air to a combustion chamber using a dual-fuel injector.

### BACKGROUND

Internal combustion engines are available in a variety of different configurations. Some are spark-ignited wherein a mixture of air and fuel (e.g., gasoline) is delivered to each of the engine's cylinders and ignited at a specific time during the engine cycle to cause combustion. The combustion moves a piston in the cylinder, causing rotation of a crankshaft, which delivers power to a drivetrain. Other engines are compression-ignited wherein a mixture of air and fuel (e.g., diesel) is delivered to each of cylinder which combusts as a result of compression of the mixture in the cylinder during the compression stroke of the piston. Again, the combustion moves the piston, which causes rotation of the crankshaft, delivering power to the drivetrain. Regardless of the ignition method, air is conventionally provided to the cylinders via intake valves connected to an intake manifold, and combustion by-products are removed via exhaust valves connected to an exhaust manifold. Conventional systems do not permit control on a cylinder-by-cylinder basis of the delivery of different types of fuel and/or air. Such individualized control of injection may provide numerous benefits in terms of engine performance. Accordingly, it is desirable to provide a system and method for controlling injection of liquid fuel, gaseous fuel and/or air for internal combustion engines at the cylinder.

### SUMMARY

According to one embodiment, the present disclosure provides a fueling system, comprising a pressurized air source; a liquid fuel source; a gaseous fuel source; a plurality of valves, each having a first input in flow communication with the pressurized air source, a second input in flow communication with the gaseous fuel source, and an output in flow communication with the first input when the valve is in an air source position and in flow communication with the second input when the valve is in a fuel source position; a plurality of dual injectors, each being coupled to a corresponding output of the plurality of valves and to the liquid fuel source, the plurality of dual injectors being mounted to directly inject liquid fuel from the liquid fuel source and one of pressurized air or gaseous fuel from the corresponding output of the plurality of valves into a corresponding plurality of combustion chambers of a plurality of engine cylinders; and a controller in communication with the plurality of dual injectors and the plurality of valves, the controller being configured to cause each of the plurality of valves to move between the air source position and the fuel source position, to control each of the dual injectors to inject pressurized air into a corresponding combustion chamber when the valve coupled to the dual injector is in the air source position and to control each of the dual injectors to inject gaseous fuel into the corresponding combustion chamber when the valve coupled to the dual injector is in the fuel source position. In one aspect of this embodiment, the gaseous fuel is natural gas.

In another embodiment of the present disclosure, a fueling system is provided, comprising a valve having a first input in flow communication with a pressurized air source, a second input in flow communication with a gaseous fuel source, and an output in flow communication with the first input when the valve is in an air source position and in flow communication with the second input with the valve is in a fuel source position; a dual injector having a first flow path in flow communication with the output of the valve and a second flow path in flow communication with a liquid fuel source; and a controller in communication with the dual injector and the valve, the controller being configured to cause the valve to move between the air source position and the fuel source position, to control the dual injector, when the valve is in the air source position, to inject liquid fuel from the second flow path and pressurized air from the first flow path directly into a combustion chamber, and to control the dual injector, when the valve is in the fuel source position, to inject liquid fuel from the second flow path and gaseous fuel from the first flow path directly into the combustion chamber. In one aspect of this embodiment, the gaseous fuel is natural gas.

In still another embodiment, the present disclosure provides a fuel system, comprising a liquid fuel source; a gaseous fuel source; and a dual injector having a first flow path in flow communication with the liquid fuel source and a second flow path in flow communication with gaseous fuel source, and an outlet in flow communication with the first and second flow paths and positioned to directly inject liquid fuel from the first flow path and gaseous fuel from the second flow path into a combustion chamber of a cylinder of an engine. One aspect of this embodiment further comprises a pump having an inlet coupled to the liquid fuel source and an outlet coupled to the first flow path of the dual injector, the pump being configured to provide liquid fuel to the first flow path. In another aspect, the engine is a spark-ignited engine, the liquid fuel is gasoline, and the gaseous fuel is hydrogen. In yet another aspect, the engine is a compression-ignited engine, the liquid fuel is diesel, and the gaseous fuel is hydrogen. In still another aspect of this embodiment, the liquid fuel is one of ammonia, liquefied petroleum gas or liquefied natural gas, and the gaseous fuel is hydrogen. Another aspect further comprises a valve coupled between the gaseous fuel source and a pressure regulator, the pressure regulator being in flow communication with the second flow path of the dual injector. A variant of this aspect further comprises a controller coupled to the dual injector and the valve to control injection of the liquid fuel and the gaseous fuel, wherein the gaseous fuel is fuel tank vapor and the controller is configured periodically activate the valve to cause the dual injector to inject the fuel tank vapors into the combustion chamber, thereby purging the fuel tank vapor. In still another aspect, the fuel system further comprises a controller coupled to the dual injector to control injection of the liquid fuel and the gaseous fuel. In a variant of this aspect, in a first mode of operation, the controller causes the dual injector to simultaneously inject both the liquid fuel and the gaseous fuel directly into the combustion chamber. In another variant, in a second mode of operation, the controller causes the dual injector to inject multiple injections of one or both of the liquid fuel and/or the gaseous fuel during a single combustion cycle. In still another variant, in a third mode of operation, the controller causes the dual injector to inject one of the liquid fuel or the gaseous fuel directly into the combustion chamber before injecting another of the liquid fuel or the gaseous fuel directly into the combustion chamber. In a further variant, the one fuel is the gaseous fuel. In yet another variant of this aspect, in a fourth mode of operation, the controller cases the dual injector to inject a first quantity of liquid fuel to act as an ignition source for a second quantity of gaseous fuel, the first quantity being smaller than the second quantity. In a further variant, the liquid fuel is diesel and the gaseous fuel is hydrogen.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a conceptual diagram of one embodiment of a fueling system according to the principles of the present disclosure;

FIG. 2 is a flowchart of a method of improving engine emissions during transient engine conditions according to the principles of the present disclosure;

FIG. 3 is a flowchart of a method of balancing cylinder torque according to the principles of the present disclosure;

FIG. 4 is a flowchart of a method of generating Hydrogen according to the principles of the present disclosure;

FIG. 5 is a conceptual diagram of another embodiment of a fueling system according to the principles of the present disclosure;

FIG. 6 is a flowchart of a method of diluting an EGR percentage according to the principles of the present disclosure;

FIG. 7 is a conceptual diagram of another embodiment of a fueling system according to the principles of the present disclosure;

FIG. 8 is a conceptual diagram of another embodiment of a fueling system according to the principles of the present disclosure;

FIG. 9 is a conceptual diagram of another embodiment of a fueling system according to the principles of the present disclosure;

FIG. 10 is a conceptual diagram of another embodiment of a fueling system according to the principles of the present disclosure;

FIG. 11 is a conceptual diagram of another embodiment of a fueling system according to the principles of the present disclosure;

FIG. 12 is a conceptual diagram of another embodiment of a fueling system according to the principles of the present disclosure; and

FIG. 13 is a conceptual diagram of another embodiment of a fueling system according to the principles of the present disclosure;

While the present disclosure is amenable to various modifications and alternative forms, specific embodiments have been shown by way of example in the drawings and are described in detail below. The present disclosure, however, is not to limit the particular embodiments described. On the contrary, the present disclosure is intended to cover all modifications, equivalents, and alternatives falling within the scope of the appended claims.

### DETAILED DESCRIPTION

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

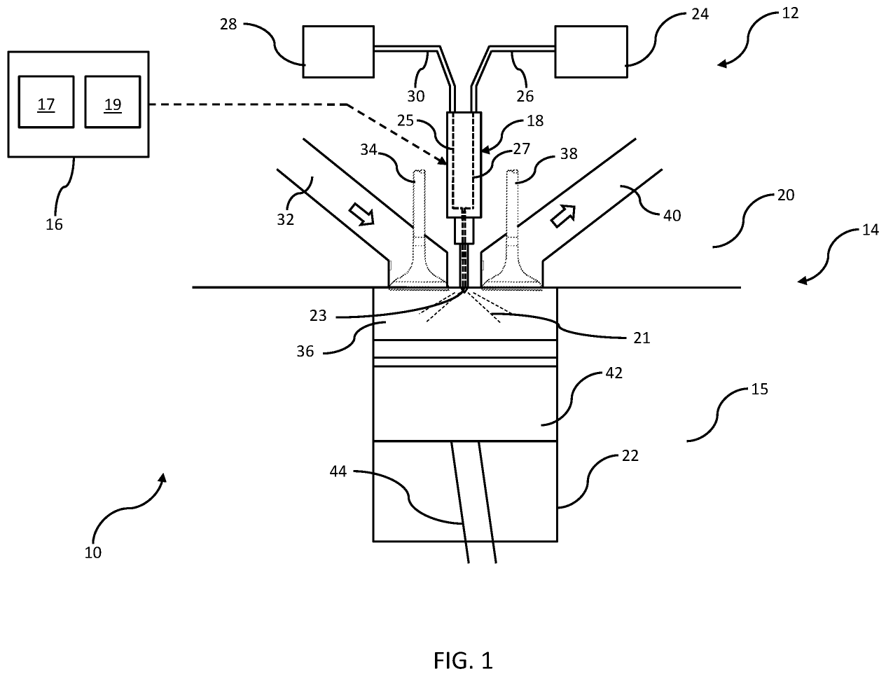

Referring now to FIG. 1, one embodiment of a system according to the present disclosure is shown. System 10 generally includes a fueling system 12, an engine 14 and a controller 16. Fueling system 12 includes a dual injector 18 mounted in a cylinder head 20 for directly injecting an air/fuel mixture (indicated by dashed lines 21) into a cylinder 22 of engine 14 formed in engine block 15. Dual injector 18 may be controlled to deliver both liquid (e.g., diesel) and gaseous (e.g., natural gas) fuel to engine cylinders. Depending upon the operating mode of engine 14 and/or the engine application, the fuel mixture may be varied using dual injector 18 from comprising all liquid to all gaseous fuel, and anywhere in between. Commercially available dual injectors 18 (e.g., the HPDI 2.0 injector manufactured by Westport Fuel Systems Inc., certain injectors manufactured by UAV Propulsion Tech., etc.) may also be used to deliver liquid fuel (e.g., diesel) and compressed or pressurized air instead of gaseous fuel. Thus, in fueling systems according to the teachings of the present disclosure, such dual injectors 18 may be used to control air delivery to individual cylinders in the manner described below.

As described below, the dual injectors in the various embodiments of the present disclosure include a first flow path in flow communication with one source of liquid fuel, gaseous fuel or pressurized air and a second flow path in flow communication with another source of liquid fuel, gaseous fuel or pressurized air. Each flow path is in flow communication with the nozzle tip 23 of the dual injector. In the embodiment depicted in FIG. 1, the first flow path is depicted as dotted line 25 and the second flow path is depicted as dotted line 27. In the various embodiments described below, the flow paths are not labeled, but it should be understood by those skilled in the art that each described dual injector includes both flow paths.

Dual injector 18 receives liquid fuel (e.g., diesel) from a liquid fuel source 24 such as a common rail accumulator via a fuel passage 26. In this embodiment of the present disclosure, dual injector 18 also receives pressurized air from a pressurized air source 28 via a pressurized air passage 30. In certain embodiments, pressurized air source 28 is an air tank typically provided for on-road heavy-duty trucks, or other vehicles such as marine vehicles and locomotives. Alternatively or in addition, pressurized air may be captured from the engine system and used as source 28. Herein, references to pressurized air denote air from whatever source having a pressure that is higher than the pressure of air at the intake valve 34 of the cylinder 22. Pressurized air may be routed directly from such an air tank via passage 30 to dual injector 18. Alternatively, one or more in-line pumps or compressors and/or accumulators may be used to increase the pressure of the pressurized air and/or one or more filters may be used to prevent contaminants and particulates from reaching dual injector 18. Operation of dual injector 18 is controlled by controller 16 as indicated by the dashed line in FIG. 1 and described herein.

As shown in FIG. 1, an inlet port 32 provides air through inlet valve 34 to combustion chamber 36 and combustion by-products or exhaust is removed from chamber 36 through exhaust valve 38 to exhaust port 40 in a conventional manner. As indicated above, as the air/fuel mixture in chamber 36 combusts, a piston 42 in cylinder 22 moves downwardly, forcing a connecting rod 44 downwardly which powers rotation of a crankshaft (not shown). Of course, in a typical engine 14 a plurality of dual injectors 18 are used to provide fuel and pressurized air to a corresponding plurality of cylinders 22 having a corresponding plurality of pistons 42 which together power rotation of the crankshaft (not shown). In FIG. 1, only one dual injector 18, one cylinder 22 and one piston 42 are depicted to simplify the drawing.

Thus, system 10 of FIG. 1 provides the ability to directly inject pressurized air under control of controller 16 into each cylinder 22 individually. By providing for direct injection of pressurized air, system 10 does not require filling of the intake manifold or otherwise upstream of intake port 32, thereby eliminating the delay associated with such an approach and the likelihood of uneven air delivery to the cylinders. Additionally, direct pressurized air injection requires a smaller volume of available pressurized air.

As shown, controller 16 generally includes a processor 17 and a non-transitory memory 19 having instructions that, in response to execution by processor 17, cause processor 17 to perform the various functions of controller 16 described herein. Processor 17, non-transitory memory 19, and controller 16 are not particularly limited and may, for example, be physically separate. Moreover, in certain embodiments, controller 16 may form a portion of a processing subsystem including one or more computing devices having memory, processing, and communication hardware. Controller 16 may be a single device or a distributed device, and the functions of the controller may be performed by hardware and/or as computer instructions on a non-transient computer readable storage medium, such as non-transitory memory 19.

In certain embodiments, controller 16 includes one or more interpreters, determiners, evaluators, regulators, and/or processors that functionally execute the operations of controller 16. The description herein including interpreters, determiners, evaluators, regulators, and/or processor emphasizes the structural independence of certain aspects of controller 16, and illustrates one grouping of operations and responsibilities of the controller. Other groupings that execute similar overall operations are understood within the scope of the present application. Interpreters, determiners, evaluators, regulators, and processors may be implemented in hardware and/or as computer instructions on a non-transient computer readable storage medium, and may be distributed across various hardware or computer based components.

Example and non-limiting implementation elements that functionally execute the operations of controller 16 include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state, any actuator including at least an electrical, hydraulic, or pneumatic actuator, a solenoid, an op-amp, analog control elements (springs, filters, integrators, adders, dividers, gain elements), and/or digital control elements.

Certain operations described herein include operations to interpret and/or to determine one or more parameters or data structures. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

System 10 may have a variety of different applications. For example, system 10 may be used to improve emissions during transient conditions, to balance cylinder operation, to increase hydrogen production while reducing the likelihood of misfire or knock as is further described below. As is known to those skilled in the art, during transient conditions such as acceleration from a stop, heavy duty diesel truck engines frequently generate undesirable quantities of black smoke as a result of incomplete combustion of the diesel fuel. The incomplete combustion results from insufficient air being delivered to the cylinders via intake ports 32 to maintain a desired air/fuel ratio as the fuel delivery is increase to satisfy the throttle request to accelerate. Under such operating conditions, dual injector 18 may directly inject additional air into chamber 36 to achieve a desired air/fuel ratio.

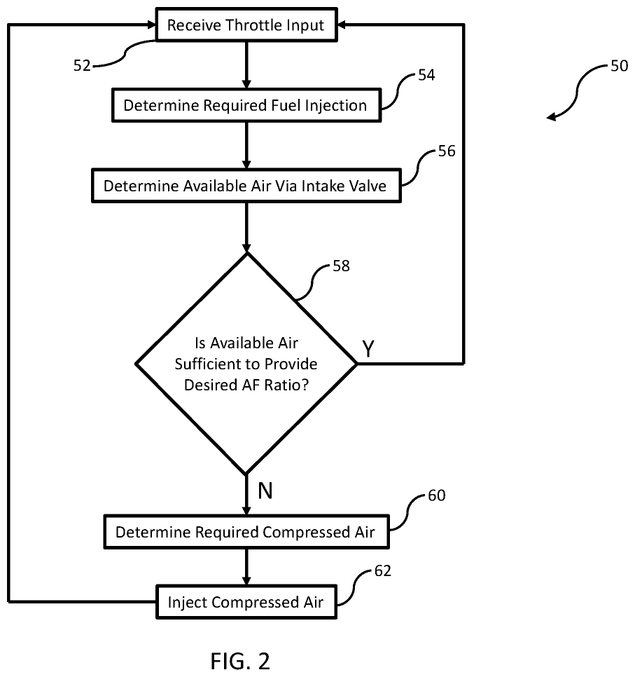

Referring now to FIG. 2, a method 50 is depicted for improving emissions during transient engine conditions. In method 50, controller 16 receives at step 52 a throttle input representing, for example, an operator's intention to accelerate. At step 54, controller 16 determines the required amount of fuel to be injected into cylinder 22 to respond to the throttle input. At step 56, controller 16 determines the available air that can be delivered to cylinder 22 via intake valve 34. At step 58, controller 16 determines whether the available air is sufficient in view of the required amount of fuel to provide a desired air/fuel ratio for the next combustion cycle. If the available air is sufficient, then the engine cycle continues without use of pressurized air, and the next throttle input is received at step 52. If the available air is insufficient, then at step 60 controller 16 determines the required amount of pressurized air needed to supplement the available air to achieve the desired air/fuel ratio. At step 62, controller 16 causes dual injector 18 to inject the required amount of pressurized air directly into cylinder 22 during the intake stroke of piston 42. After step 62, the engine cycle continues and the next throttle input is received at step 52. As a result of method 50, smoke and other by-products of insufficient combustion are reduced, thereby improving the emissions characteristics of engine 14.

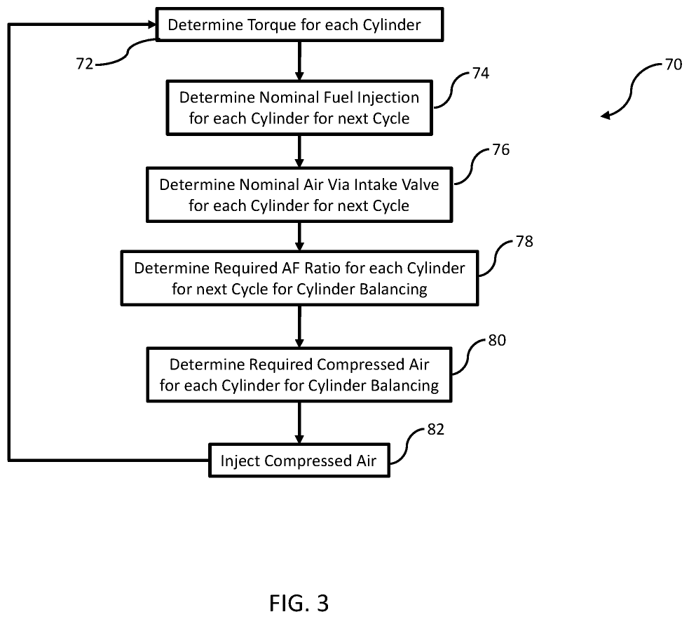

FIG. 3 depicts a method 70 for using system 10 to balance the operation of cylinders 22 in engine 14. It is known that in many engines the individual cylinders do not produce the same amount of drive torque. This imbalance may result, for example, from an unequal amount of air being provided to the cylinders because of the physical configuration of the intake manifold. The unequal torque can generate vibrations and other undesirable effects. As depicted in FIG. 3, method 70 provides individual control over the air delivered to each cylinder 22 to reduce the imbalance. In certain embodiments, dual injectors 18 capable of providing about +/−3% of the total air flow into the cylinder are used to permit cylinder balancing as described herein.

At step 72, controller 16 estimates/determines the amount of torque being delivered by each cylinder 22 for the present engine cycle. Controller 16 may determine the individual torque values using a model based approach wherein intake manifold pressure, fuel injection timing, and other operational parameters are used to estimate torque as is known by those skilled in the art. At step 74, controller 16 determines the nominal amount of fuel to be injected into each cylinder 22 for the next engine cycle to improve cylinder balancing. Similarly, at step 76 controller 16 determines the nominal intake air for each cylinder 22 to improve cylinder balancing. At step 78, controller 16 determines the required air/fuel ratio for each cylinder 22 to improve cylinder balancing and at step 82 controller 22 operates each dual injector 18 as needed to inject additional pressurized air into cylinders 22 where the air from intake valve 34 is insufficient to achieve the required air/fuel ratio.

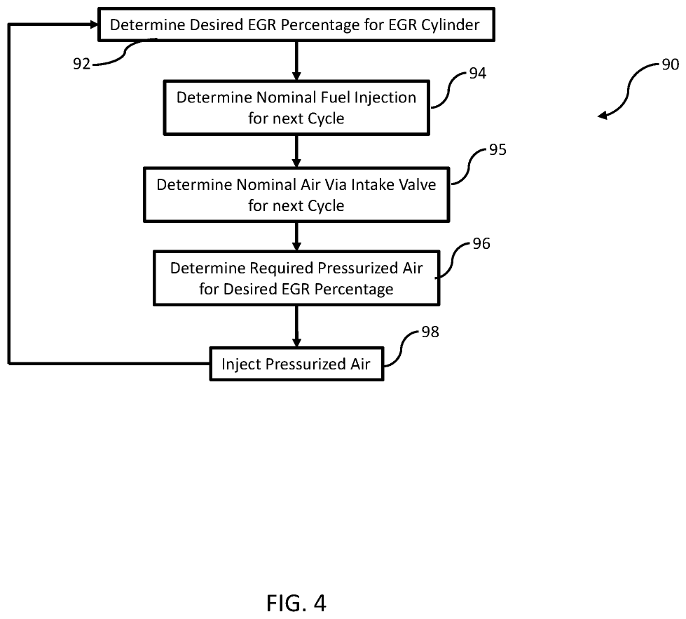

Referring now to FIG. 4, a method 90 is depicted for using system 10 to facilitate generation of additional Hydrogen without compromising the desired air/fuel ratio or the likelihood of engine misfire or knock. Pressurized air injection into dedicated cylinder(s) 22 enables additional fuel to be added while maintaining a desired air/fuel ratio. When running rich to generate Hydrogen, the additional air allows for additional hydrogen generation (via increased fueling) without compromising the desired air/fuel ratio or likelihood of misfire or knock. In certain embodiments, dual injectors 18 capable of providing about +/−15% of the total air flow into the cylinder are used to permit Hydrogen generation as described herein.

More specifically, in a dedicated EGR architecture, usually one cylinder is used for EGR with its output being supplied to the intake manifold which feeds all of the cylinders. The air/fuel ratio in the dedicated cylinder is different from the air/fuel ratio for the other cylinders. The richer the operation of the dedicated EGR cylinder, the more Hydrogen (a product of incomplete combustion) it can produce. Also, when more air is supplied to the dedicated EGR cylinder, more fuel can be used to generate more Hydrogen, which is fed back to the other cylinders, making them less likely to knock. Also, the dedicated cylinder normally produces less torque. Using the principles of the present disclosure, more air may be provided to the dedicated cylinder to increase torque and better balance the torque provided by all cylinders.

Referring back to FIG. 4, at step 92 the desired air/fuel ratio for the EGR cylinder is determined. At step 94, the nominal fuel injector for the next cycle for the EGR cylinder is determined. At step 95, the nominal air available via the intake valve for the EGR cylinder is determined. At step 96, the required amount of pressurized air for the desired air/fuel ratio is determined, and at step 98 the required amount of pressurized air is injected into the EGR cylinder.

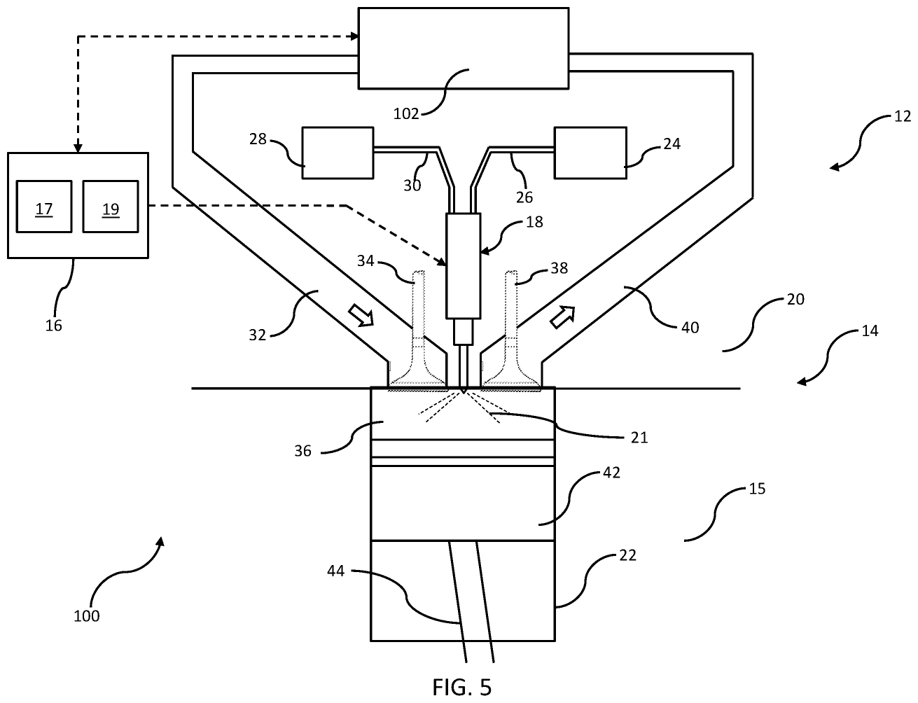

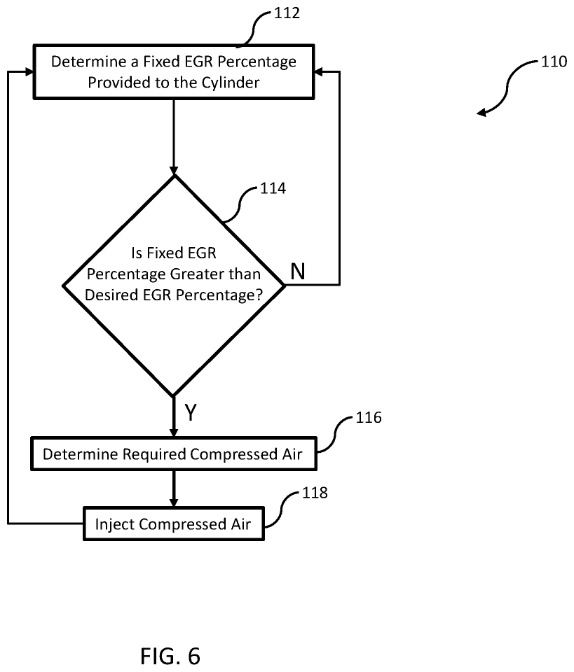

FIG. 5 depicts a system 100 that is the same as that of FIG. 1 except that it includes an exhaust gas recirculation (“EGR”) loop including EGR system 102. As is known to those skilled in the art, EGR system 102 may include an EGR cooler, an EGR valve, pressure and temperature sensors, and other components controlled by and/or in communication with controller 16. EGR system 102 is used to recirculate a portion of the exhaust from cylinders 22 back to the cylinders 22 via intake valves 34 to, for example, reduce emissions. It should be understood that the methods described above with reference to FIG. 1 may also be implemented using system 100 of FIG. 5. In system 100, one or more cylinders 22 may be dedicated for EGR dilution, and receive a fixed EGR percentage from EGR system 102. As described below with reference to FIG. 6, dual injector 18 of system 100 may be controlled to dilute the EGR percentage for any cylinder 22. In certain embodiments, dual injectors 18 capable of providing about +/−15% of the total air flow into the cylinder are used to permit EGR dilution as described herein.

Referring now to FIG. 6, a method 110 is depicted for providing EGR dilution. At step 112, controller 16 determines a fixed EGR percentage provided to a cylinder 22 by EGR system 102. At step 114, controller 16 determines whether the fixed EGR percentage is greater than a desired EGR percentage. If not, then method 110 returns to step 112. If the fixed EGR percentage is greater than the desired EGR percentage, then at step 116 controller 16 determines a required amount of pressurized air to be provided to cylinder 22 to dilute the fixed EGR percentage. At step 118, controller 16 causes dual injector 18 to inject the required amount of pressurized air into cylinder 22 to dilute the fixed EGR percentage. It should also be understood that pressurized air from dual injectors 18 may be used for EGR purge assistance (similar to cylinder scavenging). In this manner, pressurized air is provided by dual injectors 18 into cylinders 22 during the exhaust stroke of piston 42 to force combustion by-products out exhaust valve 38. In certain embodiments, one cylinder feeds all of the cylinders (e.g., in a four cylinder engine, the EGR percentage may be 25% for each cylinder). By changing the air concentration in the dedicated EGR cylinder, the EGR percentage for that cylinder may be changed.

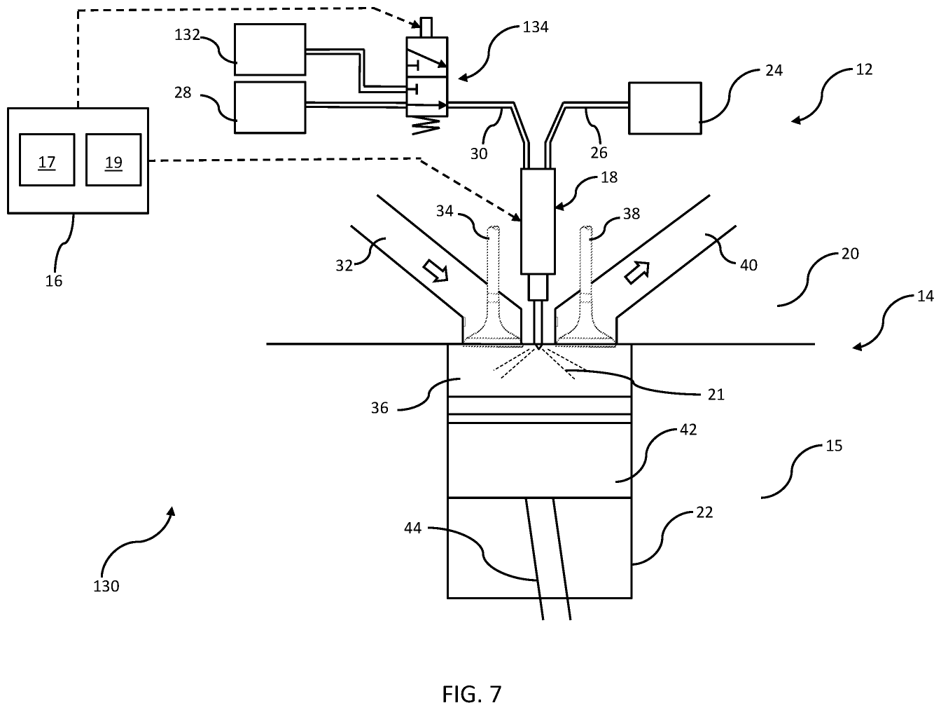

Referring now to FIG. 7, another system 130 is shown for providing pressurized air to cylinder 22 via dual injector 18. In this system 130, pressurized air is provided by pressurized air source 28 alternatively with a gaseous fuel provided by gaseous fuel source 132 via valve 134 as controlled by controller 16. When valve 134 is in the air source position shown in FIG. 7, pressurized air is supplied to dual injector 18. When controller 16 determines that gaseous fuel (such as natural gas for a dual fuel engine) is to be provided by valve 134, controller 16 actuates a solenoid of valve 134 to move valve 134 into a fuel source position, thereby connecting fuel source 132 to dual injector 18. While valve 134 is depicted as a solenoid actuated valve, it should be understood that other valve configurations may be used as is known to those skilled in the art.

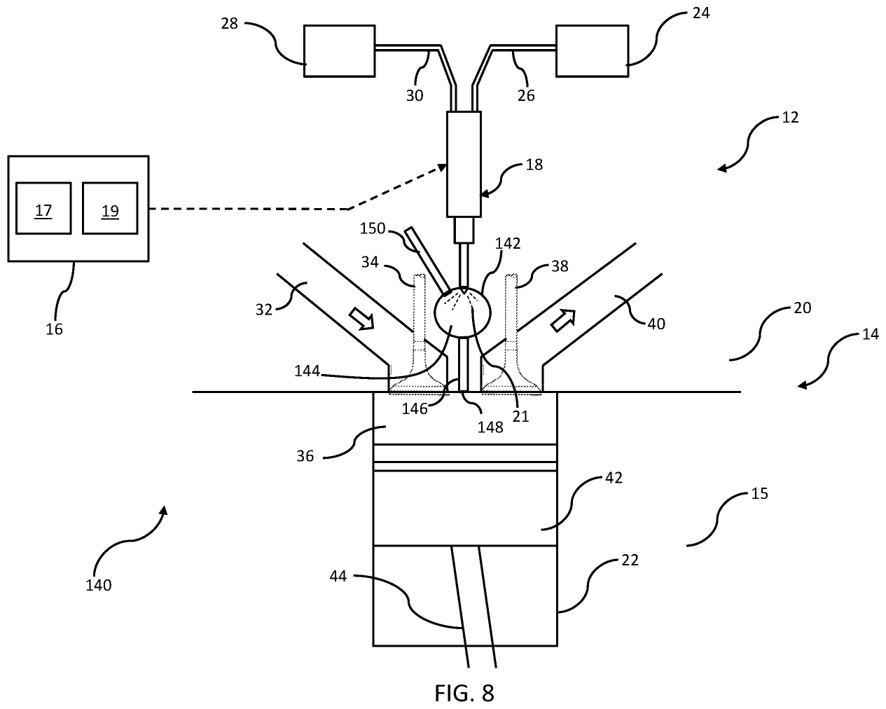

FIG. 8 depicts another system 140 wherein dual injector 18 provides pressurized air injections into a combustion pre-chamber. As is known in the art, internal combustion engines may have various combustion chamber configurations. Pre-chamber configurations may be useful for initiating and propagating the combustion flame for alternative fuel engines, such as natural gas engines. Some pre-chamber configurations permit much leaner engine operation, enabling improved fuel efficiency and reduced emissions. As shown in FIG. 8, pre-chamber 142 includes a combustion volume 144 that is in fluid communication via one or more passages 146 to main combustion chamber 36. The one or more passages 146 communicate with chamber 36 through corresponding orifices 148. A spark plug 150 extends into pre-chamber 142 to generate a spark, which initiates a flame that propagates through the pre-chamber volume 144. The flame propels through passages 146 and orifices 148 to main chamber 36 where the remainder of the combustion event occurs.

In certain applications of system 140 of FIG. 8, dual injector 18 is controlled to inject pressurized air into pre-chamber 142 to enhance flame propagation. In certain embodiments, dual injectors 18 capable of providing about +/−5% of the total air flow into the cylinder are used to permit enhanced flame propagation as described herein. In a spark-ignited engine, as the piston approaches TDC, the mixture of air and fuel is forced into pre-chamber 142. As indicated above, the mixture is ignited by spark plug 150 and a flame passes through passages 146 to ignite the mixture in the main chamber 36. Some residual exhaust, however, remains in pre-chamber 142. Dual injector 18 may be controlled to inject pressurized air into pre-chamber 142 during the exhaust stroke to purge the residual exhaust. This results in better combustion in the next cycle and therefore, improved flame propagation. In certain embodiments, the position of dual injector 18 in pre-chamber 142 may be selected to achieve improved exhaust purging (e.g., a central location as opposed to off to one side).

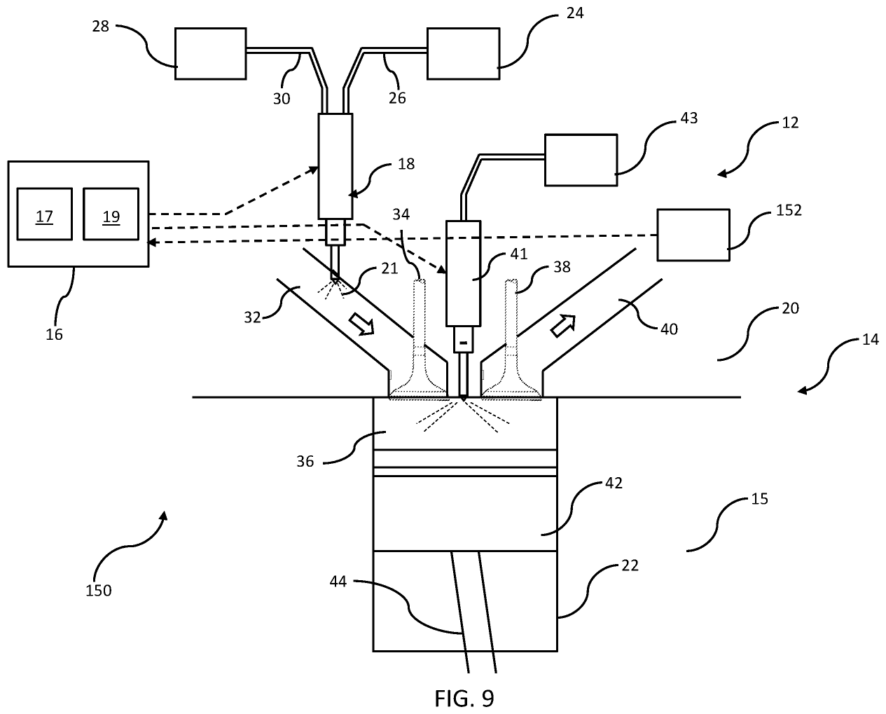

Referring now to FIG. 9, yet another system 150 is depicted wherein dual injector 18 is used to inject pressurized air and/or gaseous fuel into intake port 32. Port injection is another common method of providing an air/fuel mixture for combustion, and is often used in spark-ignited engines. Injection of fuel upstream of intake valve 34 permits additional mixing of the air and fuel prior to combustion. Controller 16 may be used to control dual injector 18 to provide the cylinder balancing, EGR dilution, EGR purge and cylinder scavenging functions described above. In FIG. 9, a standard liquid fuel injector 41 is shown coupled to a liquid fuel source 43 and configured for direct, in-cylinder liquid fuel injections into (e.g., gasoline or diesel) chamber 36.

In any of the systems described above, one or more oxygen sensors may be positioned downstream of exhaust port 40 (such as sensor 152 in FIG. 9) to sense the Oxygen content of exhaust and provide Oxygen measurements to controller 16 as indicated by the dashed line. In certain embodiments, controller 16 may control dual injector 18 to perform on-board diagnostics (“OBD”) of the one or more sensors 152 in the manner described below. Controller 16 may actuate dual injector 18 post-combustion to inject a predetermined quantity of pressurized air into cylinder 22 (e.g., during idle operating conditions), which is removed along with exhaust during the exhaust stroke of piston 42. The predetermined quantity of air could be used to check the response rate of sensor 152 and/or to determine if sensor 152 can detect a lean exhaust by-product. In this manner, lean combustion events may be avoided, but a lean exhaust by-product may be created for the purpose of Oxygen sensor 152 diagnostics.

Standard OBD today is typically performed during a no fueling event wherein air is flushed through system and a step change in sensor 152 is detected. As sensor 152 degrades, the step change gets slower and slower. With this approach, however, substantial amounts of Oxygen are provided to the exhaust catalyst, which prevents it from processing exhaust for a period of time. Using the principles disclosed herein, a smaller quantity of air may be injected with dual injector 18 to allow checking of sensor 152 without such an emissions problem for the catalyst.

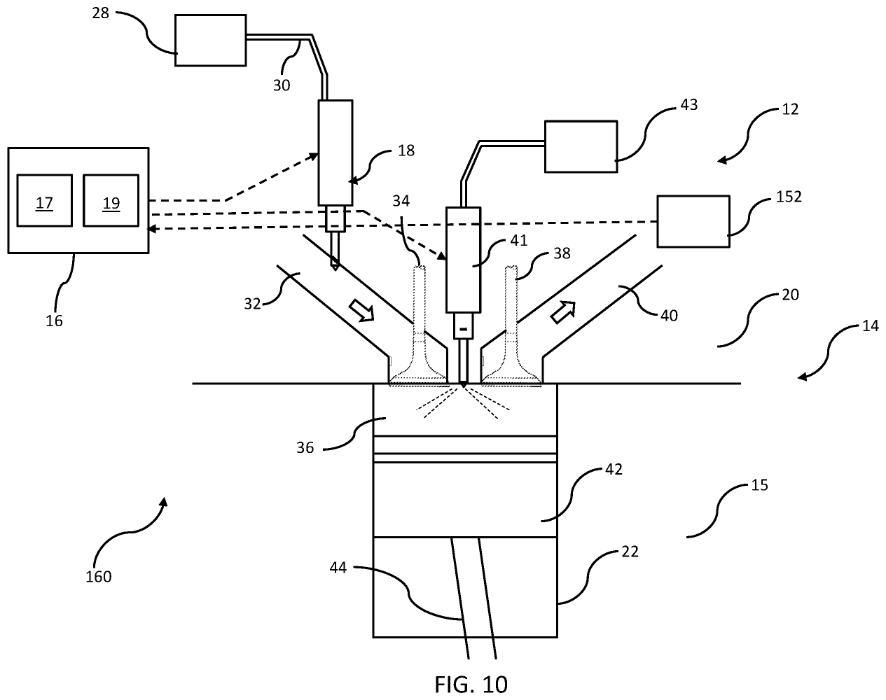

FIG. 10 depicts a system 160 that is very similar to system 150 of FIG. 9 except that dual injector 18 in FIG. 10 is only used to inject pressurized air, not a gaseous fuel.

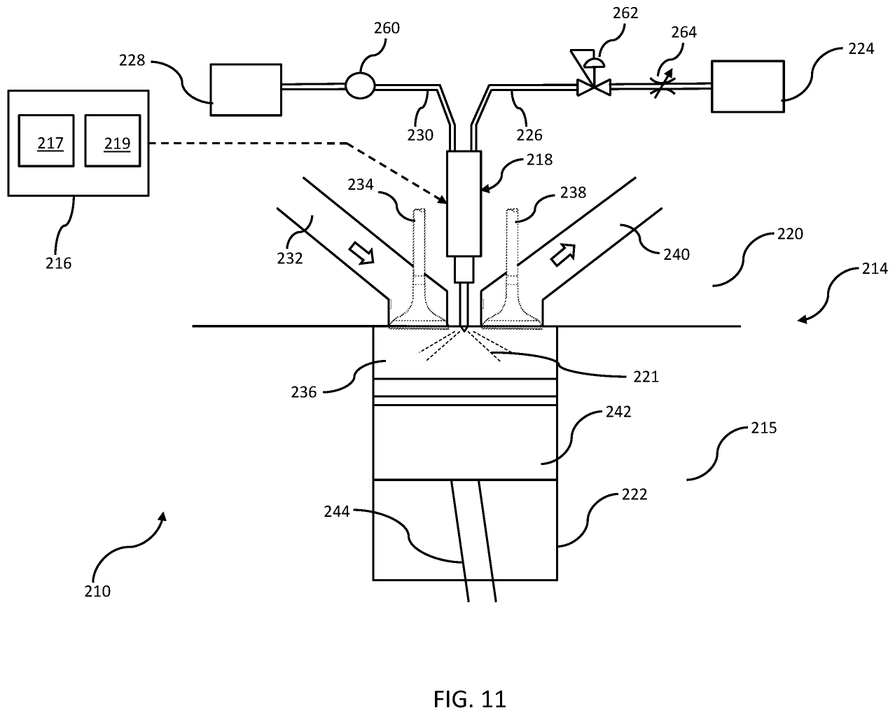

Referring now to FIG. 11, another embodiment of a system according to the present disclosure is shown. System 210 generally includes a fueling system 212, an engine 214 and a controller 216. Fueling system 212 includes a dual injector 218 mounted in a cylinder head 220 for directly injecting a liquid fuel and a gaseous fuel (indicated by dashed lines 221) into a cylinder 222 of engine 214 formed in engine block 215. Depending upon the operating mode of engine 214 and/or the engine application, the fuel mixture may be varied using dual injector 218 from comprising all liquid to all gaseous fuel, and anywhere in between. Commercially available dual injectors 218 (e.g., the HPDI 2.0 injector manufactured by Westport Fuel Systems Inc., certain injectors manufactured by UAV Propulsion Tech., etc.) may be used.

Dual injector 218 receives liquid fuel (e.g., diesel) from a liquid fuel source 228 via a pump 260 and a fuel passage 230. In this embodiment of the present disclosure, dual injector 218 also receives gaseous fuel from a gaseous fuel source 224 via a valve 264, a pressure regulator 262 and a gaseous fuel passage 226. Operation of dual injector 218 is controlled by controller 216 as indicated by the dashed line in FIG. 11 and described herein. Controller 216 also controls operation of pump 260, pressure regulator 262, and valve 264.

As shown in FIG. 11, an inlet port 232 provides air through inlet valve 234 to combustion chamber 236 and combustion by-products or exhaust is removed from chamber 236 through exhaust valve 238 to exhaust port 240 in a conventional manner. As indicated above, as the fuel mixture in chamber 236 combusts, a piston 242 in cylinder 222 moves downwardly, forcing a connecting rod 244 downwardly which powers rotation of a crankshaft (not shown). Of course, in a typical engine 214 a plurality of dual injectors 218 are used to provide fuel and air to a corresponding plurality of cylinders 222 having a corresponding plurality of pistons 242 which together power rotation of the crankshaft (not shown). In FIG. 11, only one dual injector 218, one cylinder 222 and one piston 242 are depicted to simplify the drawing.

Thus, system 210 of FIG. 11 provides the ability to directly inject liquid and gaseous fuel under control of controller 216 into each cylinder 222 individually. As shown, controller 216 generally includes a processor 217 and a non-transitory memory 219 having instructions that, in response to execution by processor 217, cause processor 217 to perform the various functions of controller 216 described herein. Processor 217, non-transitory memory 219, and controller 216 are not particularly limited and may, for example, be physically separate. Moreover, in certain embodiments, controller 216 may form a portion of a processing subsystem including one or more computing devices having memory, processing, and communication hardware. Controller 216 may be a single device or a distributed device, and the functions of the controller may be performed by hardware and/or as computer instructions on a non-transient computer readable storage medium, such as non-transitory memory 219.

System 210 may have a variety of different applications suitable for using various types of fuels. For example, liquid fuel source 228 may provide gasoline, diesel, ethanol, ammonia, liquefied petroleum gas (“LPG”) or liquefied natural gas (“LNG”). Gaseous fuel source 224 may provide hydrogen, natural gas, methane or some other type of gaseous fuel, including liquid fuel vapor as described below. In certain embodiments, hydrogen is used as the gaseous fuel and the liquid fuel is one of gasoline, diesel, ammonia, LPG or LNG. In such embodiments, the hydrogen tends to accelerate combustion of the liquid fuel, which improves fuel efficiency and reduces undesirable emissions. Use of hydrogen as the gaseous fuel lowers CO2 emissions because hydrogen is a zero-carbon fuel.

Additionally, hydrogen is beneficial for the conversion of NOx in the after-treatment system. More specifically, hydrogen is particularly effective in increasing the temperature of the exhaust to more quickly achieve the catalyst light-off temperature of the diesel oxidation catalyst of the after-treatment system (not shown). Thus, under cold start conditions, for example, controller 216 may cause injector 218 to inject a higher proportion of hydrogen to reach the light-off temperature more quickly, thereby reducing emissions. Similarly, higher proportions of hydrogen may be used to rapidly increase the temperature of the exhaust to facilitate regeneration of the diesel particulate filter of the after-treatment system (not shown). In the manner described herein, hydrogen may be used to provide improved thermal management of the after-treatment system.

As should be understood, in the embodiment depicted in FIG. 11, gaseous fuel in gaseous fuel source 224 is pressurized. As such, when controller 216 opens valve 264, pressure regulator 262 reduces the pressure of the gaseous fuel to a level appropriate for injection by injector 218.

It should also be understood that unlike conventional systems that use separate injectors for different types of fuel, which can result in overheating of either injector during times where it is not injecting fuel, in the embodiments described herein, particularly where hydrogen is used as the gaseous fuel, the dual injector configuration permits injection of the liquid fuel (e.g., diesel) to cool the injector tip and avoid pre-ignition.

Additionally, in certain applications system 210 of FIG. 11 may be used with an engine 214 having a dedicated exhaust gas recirculation (“EGR”) cylinder. In such an engine 214, the EGR cylinder functions as a donor cylinder and may provide a reduced amount of exhaust to the after-treatment system or no exhaust at all. In one application, when cylinders of the engine are run rich, additional hydrogen could be added to the EGR cylinder such that when routed through inlet port 232 of the other cylinders, the additional hydrogen causes accelerated combustion and reduces knock associated with rich operation. Moreover, with such fueling control, engine 214 may provide higher torque similar to that of a diesel engine.

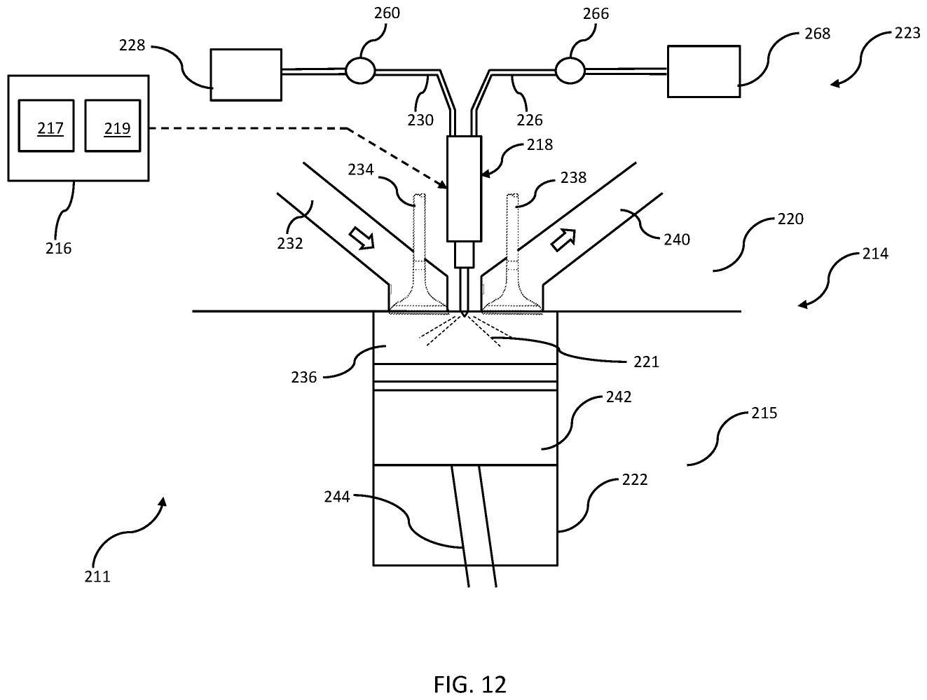

Referring now to FIG. 12, another embodiment of the present disclosure is shown. System 211 of FIG. 12 is similar to the embodiment of FIG. 11, except valve 264 and pressure regulator 262 are replaced with pump 266 and gaseous fuel source 224 is replaced with a second liquid fuel source 268. In this embodiment, dual fuel injector 218 injects two different liquid fuels. Various different combinations of liquid fuels may be used depending upon the application. For example, and without limitation, the first liquid fuel delivered from liquid fuel source 228 could be gasoline and the second liquid fuel delivered from second liquid fuel source 268 could be liquefied natural gas, or the first liquid fuel could be diesel while the second liquid fuel is ammonia.

It should be understood that in any of the embodiments described above, the controller may implement a variety of different injection methods depending upon the application. For example, both fuels may be injected simultaneously. Alternatively or additionally, one or both of the fuels may be injected multiple times during a single combustion cycle (i.e., multi-pulse injections). Moreover, the sequence of injection of the fuel types may be controlled. For example, one fuel type (e.g., gaseous fuel) may be injected before the other fuel type (e.g., liquid fuel) to allow for in-cylinder mixing prior to injection of the main fuel charge (e.g., liquid). In another example, the gaseous fuel may be injected after the liquid fuel to provide higher temperature exhaust for the after-treatment thermal management functions described above. Additionally, the quantities of fuel may be controlled to enhance combustion. For example, one fuel such as diesel may be injected in a small quantity to act as an ignition source for the second fuel in a process known as micro-pilot injection.

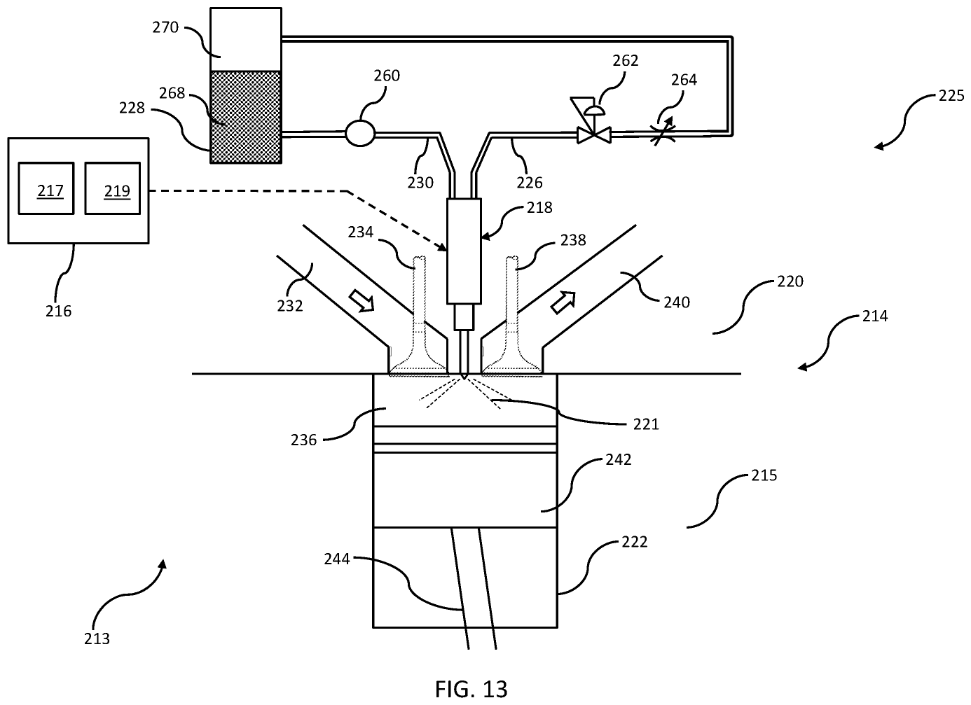

Referring now to FIG. 13, another embodiment of a fueling system according to the present disclosure is shown. System 213 of FIG. 13 is similar to that of FIG. 11 except that instead of a separate gaseous fuel source 224, the embodiment of FIG. 13 uses fuel vapors from liquid fuel source 228 as the gaseous fuel. More specifically, pump 260 is connected to liquid fuel source 228 to pump liquid fuel 268 to one flow path of dual injector 218 and valve 264 is connected to liquid fuel source 228 to route fuel vapor 270 to dual injector 218. In this manner, fuel vapor 270 thereby functions as the gaseous fuel and controller 216 may be configured to periodically purge the fuel vapors 270 of liquid fuel source 216 into combustion chamber 236.

It should be further understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A fueling system, comprising:
a pressurized air source;
a liquid fuel source;
a gaseous fuel source;
a plurality of valves, each having a first input in flow communication with the pressurized air source, a second input in flow communication with the gaseous fuel source, and an output in flow communication with the first input when the valve is in an air source position and in flow communication with the second input when the valve is in a fuel source position;
a plurality of dual injectors, each being coupled to a corresponding output of the plurality of valves and to the liquid fuel source, the plurality of dual injectors being mounted to directly inject liquid fuel from the liquid fuel source and one of pressurized air or gaseous fuel from the corresponding output of the plurality of valves into a corresponding plurality of combustion chambers of a plurality of engine cylinders; and
a controller in communication with the plurality of dual injectors and the plurality of valves, the controller being configured to cause each of the plurality of valves to move between the air source position and the fuel source position, to control each of the dual injectors to inject pressurized air into a corresponding combustion chamber when the valve coupled to the dual injector is in the air source position and to control each of the dual injectors to inject gaseous fuel into the corresponding combustion chamber when the valve coupled to the dual injector is in the fuel source position.

2. The fueling system of claim 1, wherein the gaseous fuel is natural gas.

3. A fueling system, comprising:
a valve having a first input in flow communication with a pressurized air source, a second input in flow communication with a gaseous fuel source, and an output in flow communication with the first input when the valve is in an air source position and in flow communication with the second input with the valve is in a fuel source position;
a dual injector having a first flow path in flow communication with the output of the valve and a second flow path in flow communication with a liquid fuel source; and
a controller in communication with the dual injector and the valve, the controller being configured to cause the valve to move between the air source position and the fuel source position, to control the dual injector, when the valve is in the air source position, to inject liquid fuel from the second flow path and pressurized air from the first flow path directly into a combustion chamber, and to control the dual injector, when the valve is in the fuel source position, to inject liquid fuel from the second flow path and gaseous fuel from the first flow path directly into the combustion chamber.

4. The fueling system of claim 3, wherein the gaseous fuel is natural gas.

5. A fuel system, comprising:
a liquid fuel source;
a gaseous fuel source; and
a dual injector having a first flow path in flow communication with the liquid fuel source and a second flow path in flow communication with gaseous fuel source, and an outlet in flow communication with the first and second flow paths and positioned to directly inject liquid fuel from the first flow path and gaseous fuel from the second flow path into a combustion chamber of a cylinder of an engine.

6. The fuel system of claim 5, further comprising a pump having an inlet coupled to the liquid fuel source and an outlet coupled to the first flow path of the dual injector, the pump being configured to provide liquid fuel to the first flow path.

7. The fuel system of claim 5, wherein the engine is a spark-ignited engine, the liquid fuel is gasoline, and the gaseous fuel is hydrogen.

8. The fuel system of claim 5, wherein the engine is a compression-ignited engine, the liquid fuel is diesel, and the gaseous fuel is hydrogen.

9. The fuel system of claim 5, wherein the liquid fuel is one of ammonia, liquefied petroleum gas or liquefied natural gas, and the gaseous fuel is hydrogen.

10. The fuel system of claim 5, further comprising a valve coupled between the gaseous fuel source and a pressure regulator, the pressure regulator being in flow communication with the second flow path of the dual injector.

11. The fuel system of claim 10, further comprising a controller coupled to the dual injector and the valve to control injection of the liquid fuel and the gaseous fuel, wherein the gaseous fuel is fuel tank vapor and the controller is configured periodically activate the valve to cause the dual injector to inject the fuel tank vapors into the combustion chamber, thereby purging the fuel tank vapor.

12. The fuel system of claim 5, further comprising a controller coupled to the dual injector to control injection of the liquid fuel and the gaseous fuel.

13. The fuel system of claim 12, wherein in a first mode of operation, the controller causes the dual injector to simultaneously inject both the liquid fuel and the gaseous fuel directly into the combustion chamber.

14. The fuel system of claim 12, wherein in a second mode of operation, the controller causes the dual injector to inject multiple injections of one or both of the liquid fuel and/or the gaseous fuel during a single combustion cycle.

15. The fuel system of claim 12, wherein in a third mode of operation, the controller causes the dual injector to inject one of the liquid fuel or the gaseous fuel directly into the combustion chamber before injecting another of the liquid fuel or the gaseous fuel directly into the combustion chamber.

16. The fuel system of claim 15, wherein the one fuel is the gaseous fuel.

17. The fuel system of claim 12, wherein in a fourth mode of operation, the controller cases the dual injector to inject a first quantity of liquid fuel to act as an ignition source for a second quantity of gaseous fuel, the first quantity being smaller than the second quantity.

18. The fuel system of claim 17, wherein the liquid fuel is diesel and the gaseous fuel is hydrogen.
